(19) United States
(12) Patent Application Publication
(10) Pub. No.: US 2020/0166773 A1
(43) Pub. Date: May 28, 2020

(54) EYEGLASS PARTS AND EYEGLASSES PROVIDED WITH THE SAME

(71) Applicant: OHGI TECHNOLOGICAL CREATION CO., LTD., Otsu-shi, Shiga (JP)

(72) Inventor: Takehiko OHGI, Otsu-shi, Shiga (JP)

(21) Appl. No.: 16/612,975

(22) PCT Filed: Oct. 22, 2018
(86) PCT No.: PCT/JP2018/039153

§ 371 Date: Nov. 12, 2019

(30) Foreign Application Priority Data
Dec. 14, 2017 (JP) 2017-239165

(51) Int. Cl. G02C 5/12; G02C 5/00; G02C 5/14

(52) U.S. Cl. CPC G02C 5/12; G02C 5/143; G02C 5/008

(57) ABSTRACT

A light-weighted eyeglass part that constitutes eyeglasses has a far-infrared ray effect or thermal radiation, or a stress reduction effect, and the eyeglass part is characterized by containing a carbon material that has a carbon purity of 90% or greater and that is crystallized by a heat-treatment at 2000 degrees C. or higher.

### CROSS REFERENCE TO RELATED APPLICATIONS

This application is a U.S. National Stage of PCT Application No. PCT/JP2018/03915, filed on Oct. 22, 2018, which claims priority to Japanese Patent Application No. 2017-239165 filed on Dec. 14, 2017, the disclosures of which are hereby incorporated in their entirety by reference herein.

### TECHNICAL FIELD

The present invention relates to eyeglass parts including nose pads and temple tips that constitute parts of eyeglasses and to eyeglasses provided with these parts.

### BACKGROUND ART

Conventionally, various eyeglasses made with a carbon material have been proposed.

A patent document 1 described below discloses a resin-made injection-molded eyeglass frame product that is molded by mixing a bamboo carbon fine powder with a pelletized material. According to this, it is regarded that the bamboo carbon absorbs chemical substances so that it prevents health damages. A patent document 2 described below discloses that a front main body, which constitutes a front part of an eyeglass frame, is integrally molded by using carbon fiber as a main material, and that a reinforcing member, which is formed with titanium or titanium alloys, is attached along a rim of the main body. Accordingly, it is regarded that the eyeglass frame is light-weighted.

### CITATION LIST

### Patent Documents

Patent Document 1: Japanese Unexamined Patent Application Publication No. 2004-61575

Patent Document 2: Japanese Unexamined Patent Application Publication No. 2011-90201

### SUMMARY OF INVENTION

### Problems to be Solved by Invention

According to the patent document 1, since the bamboo carbon, which blackens the objects being touched, is used as a carbon material, it is difficult to handle in a manufacturing process. For example, the use of the bamboo carbon blackens a production apparatus, a mold for molding, a hopper and others. A problem with this is that the apparatus is used solely for the eyeglass frame with the bamboo carbon and is not used for the eyeglass frame without the bamboo carbon.

According to the patent document 2, its object is to make the frame light-weighted so that the frame is not developed by focusing on a far-infrared ray effect or heat dispersing property, a deodorizing effect, a stress reduction effect, and the like. Not every carbon material can exert those effects that are known as the carbon material has. It is important that what kind of carbon material it is, and how the carbon material is incorporated.

The present invention is proposed in view of such circumstances, and an object of the present invention is to provide light-weighted eyeglass parts and eyeglasses provided with these parts, which have a far-infrared ray effect or heat dispersing property, a stress reduction effect, and so forth.

### Solution to Problem

To achieve the above-described object, an eyeglass part according to one aspect of the present invention constitutes a part of eyeglasses, and is characterized by containing a carbon material that has a carbon purity of 90% or greater and that is crystallized by a heat treatment at 2000 degrees C. or higher.

### SUMMARY OF INVENTION

The eyeglass parts and the eyeglasses provided with these parts are light-weighted and can have a far-infrared ray effect or heat dispersing property, a stress reduction effect, and so forth due to the above-described composition.

### BRIEF DESCRIPTION OF DRAWINGS

FIG. 1A is a schematic perspective view illustrating an eyeglass part (a nose pad) in accordance with the first embodiment of the present invention, FIG. 1B is a schematic cross-sectional view illustrating the eyeglass part, and FIG. 1C is a schematic perspective view illustrating an example of eyeglasses provided with the eyeglass parts.

FIG. 2A is a schematic front view illustrating an eyeglass part (a nose pad) in accordance with a second embodiment of the present invention, and FIG. 2B is a schematic back view showing the eyeglass part. FIGS. 2C and 2D are cross-sectional views illustrating an attachment process of the eyeglass part taken along X-X line in FIG. 2A. FIGS. 2E and 2F are diagrams illustrating an example of a variation wherein the eyeglass part has a magnet, and an attachment process of the variation is illustrated.

FIG. 3A is a schematic perspective view illustrating a state before attaching the eyeglass part (the nose pad) on eyeglasses in accordance with the second embodiment, and FIG. 3B is a schematic perspective view illustrating a state after attaching the eyeglass part to the eyeglasses shown in FIG. 3A.

FIG. 4A is a schematic front view showing an eyeglass part (a nose pad) in accordance with the third embodiment of the present invention, and FIG. 4B is a schematic back view showing the eyeglass part. FIGS. 4C and 4D are cross-sectional views illustrating an attachment process of the eyeglass part taken along Y-Y line in FIG. 4A. FIGS. 4E and 4F are diagrams illustrating an example of a variation wherein the eyeglass part has a magnet, and an attachment process of the variation is illustrated.

FIG. 5A is a schematic front view illustrating a base of an eyeglass part (a nose pad) in accordance with the fourth embodiment of the present invention, and FIG. 5B is a schematic back view showing the base of the eyeglass part. FIGS. 5C and 5D are diagrams illustrating an attachment process of the eyeglass part, and FIG. 5C is a cross-sectional view taken along Z-Z line in FIG. 5A. FIG. 5E is a schematic perspective view of the eyeglass part in accordance with the fourth embodiment.

FIG. 6A is a schematic front view illustrating an eyeglass part (a nose pad) in accordance with the fifth embodiment of the present invention, and FIG. 6B is a schematic back view illustrating the eyeglass part.

FIG. 7A is a schematic perspective view illustrating a state before attaching the eyeglass part (the nose pad) to eyeglasses in accordance with the fifth embodiment, and FIG. 7B is a schematic perspective view showing a state after attaching the eyeglass part to the eyeglasses shown in FIG. 7A.

FIG. 8A is a schematic front view illustrating an eyeglass part (a temple tip) in accordance with the sixth embodiment of the present invention, and FIG. 8B is a schematic perspective view showing an example of the eyeglasses provided with the eyeglass part.

FIG. 9A is a schematic front view showing an eyeglass part (a temple tip) in accordance with the seventh embodiment of the present invention, and FIG. 9B is an illustrative diagram of a state before attaching a projecting part to the eyeglass part. FIG. 9C is a side view of the projecting part, and FIG. 10D is a schematic cross-sectional view illustrating a variation of the projecting part.

FIGS. 10A to 10D are illustrative diagrams of a structure of an eyeglass part (a temple tip) in accordance with the eighth embodiment of the present invention, FIGS. 10A and 10C are schematic perspective views illustrating the eyeglass part, FIG. 10B is a schematic front view showing the eyeglass part, and FIG. 10C is a schematic perspective view showing a pot assembled to the eyeglass part.

FIGS. 11A to 11C are illustrative diagrams of a structure of an eyeglass part (a temple tip) in accordance with the ninth embodiment of the present invention, FIG. 11A is a schematic perspective view showing the eyeglass part, FIG. 11B is a schematic front view showing the eyeglass part, and FIG. 11C is a schematic perspective view showing a pot to be assembled to the eyeglass part.

FIG. 12A is a schematic front view illustrating an eyeglass part (a temple tip) in accordance with the tenth embodiment of the present invention, and FIGS. 12B and 12C are schematic front views showing another example of the eyeglass part (the temple tip).

FIG. 13A is a schematic perspective view illustrating a state before attaching an eyeglass part (a nose pad and a temple tip) on eyeglasses in accordance with the eleventh embodiment of the present invention, and FIG. 13B is a schematic perspective view showing a state after attaching the eyeglass part to the eyeglasses shown in FIG. 13A.

FIGS. 14A, 14C, and 14D are schematic plan views showing examples of various shapes of an eyeglass part (a nose pad) in accordance with the eleventh embodiment, and FIG. 14B is a cross-sectional view taken along W-W line in FIG. 14A.

FIGS. 15A, 15C, and 15D are schematic plan views showing examples of various shapes of an eyeglass part (a nose pad), and FIG. 15B is a cross-sectional view taken along W′-W′ line in FIG. 15A.

### DESCRIPTION OF EMBODIMENTS

Eyeglass parts according to the embodiments of one aspect of the present invention are described hereinafter with reference to the drawings.

The eyeglass part 1 in these embodiments is applied to, for example, a nose pad 21 and a temple tip 26 that constitute the parts of eyeglasses 2. The eyeglass parts 1 and 1A to 1L according to the first to the eleventh embodiments are described, and all of the parts contains a carbon material that has a carbon purity of 90% or greater and that is crystallized by a heat treatment at 2000 degrees C. or higher.

Detailed descriptions are provided below.

### First Embodiment

(Structure of Eyeglasses)

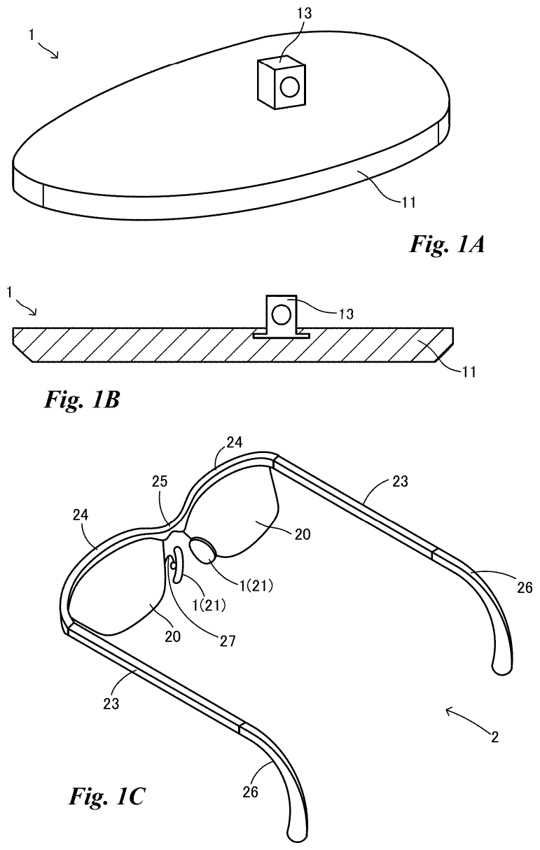

FIG. 1 illustrates the eyeglass part 1 in accordance with the first embodiment. The eyeglass part 1 shown here is used as a nose pad. Nose pads 21 and 21 are parts to support the eyeglasses 2 by applying them so as to hold a wearer's nose from both sides of the nose. The eyeglasses 2 to which the eyeglass parts 1 and 1 are attached have lenses 20 and 20, the nose pads 1 and 1 (21, 21), temples 23 and 23, rims 24 and 24, a bridge 25, and temple tips 26 and 26, and a pad arm 27, clings, supports the nose pad 21 as shown in FIG. 1C.

A structure of the eyeglasses 2 is not limited to an example shown in the drawings. For example, the eyeglasses 2 is not required to have the lenses 20 and 20, or can be either with diopter or no diopter, or can be sunglasses when the lenses 20 and 20 are attached. Further, the eyeglasses can be a glasses-like wearable terminal with a communication function, video viewing and music listening functions and others. A shape of the nose pad 21 is not limited to an example shown in the drawings, but it can be integrally formed with the rim 24.

(Eyeglass Part 1)

The eyeglass part 1 shown in FIG. 1A and FIG. 1B has a base 11 approximately in the shape of a rice grain and a connection part 13 to be connected to a pad arm 27, and in the example the eyeglass part 1 itself constitutes the nose pad 21.

The base 11 in contact with the wearer's nose is formed by containing 20 to 50% of graphite particles of 3 to 5 micrometers relative to a thermoplastic resin material.

The graphite particles used as a carbon material, which have a carbon purity of 90% or greater and that are crystallized by a heat treatment at 2000 degrees C. or higher, are, for example, artificial graphite, scaly graphite, or acetylene black that are pulverized and fined to more or less 3 to 5 micrometers. These all have the carbon purity of 90% or greater. The thermoplastic resin materials are, for example, polypropylene, silicone, polystyrene, polyamide, halogenated vinyl resin, polyacetal, polyester, polycarbonate, polyarylsulfone, polyarylketone, polyphenyleneether, polyphenylenesulfide, polyaryletherketone, polyethersulfone, polyphenylenesulfidesulfone, polyarylate, liquid crystal polyester, and fluororesin. These can be used individually or in combination of two or more of these.

Such resin material is added with the above-described graphite particles by 20 to 50% and is pelletized. The connection part 13 is set into a mold, and the pellets melt by heat are supplied into the mold and molded by injection.

The finer a granularity of the graphite particles for use is, the better the graphite particles are, and the more the graphite particles are contained in the resin material, the higher effect can be expected. However, some raw materials of the crystallized carbon materials are hard to be finely pulverized. Further, depending on the resin materials to be mixed with, the resin materials are not well mixed with the graphite particles. In fact, the graphite particles have various problems in the injection molding. For example, although acetylene black is easily made to be fine particles and has high electroconductivity, it is hard to be mixed with the resin material. As a result of various tests conducted by an inventor, crystallization of the carbon materials by baking at a high temperature is essential to increase electroconductivity. The inventor has found out that the use of the carbon materials by being pulverized to more or less 3 to 5 micrometers is optimum to mix the carbon materials with the above-described resin material and to perform the injection molding. Pulverizing the above-described graphite particles evenly to less than 3 micrometers is difficult. The graphite particles which are more than 5 micrometers tend to have difficulty in being mixed with the resin materials. Further, when the graphite particles contained in the resin material are less than 20%, there is a tendency that high electroconductivity is not expected. When the graphite particles contained are more than 50%, there is a tendency that the injection molding is not performed well.

According to the above, mass production of the light-weighted eyeglass part 1 having high electroconductivity and high thermal conductivity, as well as a far-infrared ray effect and a heat dispersing property, a stress reduction effect, and the like is achieved. Also, the above-described carbon materials hardly blacken production apparatuses including the mold unlike the bamboo carbon.

A mechanism of electroconductivity and the far-infrared ray effect of the carbon materials having the carbon purity of 90% or greater and being crystallized by the heat treatment at 2000 degrees C. or higher have, is described below.

A human body consists of 60% water and 25% carbon, and the human body constantly emits far-infrared rays of 10 microns at an average body temperature of 36.5 degrees C. In contrast, as described above, the carbon materials crystallized by baking at the high temperature have high thermal conductivity and good heat-absorption due to its high electroconductivity. Thus, when the above-described carbon materials come into contact with or come closer to skin of the human body, the human body is warmed by absorbing far-infrared rays. In other words, when both carbon materials and the human body respectively emit equal wavelength of far-infrared rays, the carbon materials keep approximately 36.5 degrees C., while water molecules strongly collide inside the body. This oscillation becomes motion energy, which is converted to heat, and the body is warmed.

As a result, blood flow is improved because far-infrared rays act on subcutaneous tissues and blood vessels. The inventor confirms an effect of 15% increase of blood flow in peripheral and central vessels. Further, it is considered that these carbon materials heal the body and reduce fatigue by generating alpha waves, thereby these contribute to a health promotion. Furthermore, according to test results obtained, stress (tension, anxiety, depression, confusion) is reduced by introducing the carbon materials into a part of the existing eyeglasses 2, thereby such an eyeglass part 1 is surely very useful in the stressed society these days.

This mechanism is also applied when carbon materials such as a carbon fiber reinforced carbon composite (C/C composite) or an isotropic high density carbon material, which are to be described below, are used for the eyeglass parts.

A surface of the eyeglass part 1 (a surface in contact with the wearer's nose) can be coated with diamond-like carbon (hereinafter referred to as “DLC”). DLC is mainly made of carbon and configured by an amorphous structure (a non-crystalline structure). Methods of coating DLC are, for example, a sputter deposition, a chemical reaction with gas, a vapor deposition, and a dope method. When a thickness of DLC is nano-level, DLC is still hard and low-wearing, and has high wettability. That allows the eyeglass part 1 to have high strength. A thickness of DLC layer can be, for example, 5 to 10 micrometers, or a thin layer of 0.05 to 1.5 micrometers.

Further, the whole surface of the eyeglass part 1 can be coated with a coating material for coloring to a desired color, and then DLC can be applied over that coat. The base 11 is black as being composed of the carbon material. However, when the coating material for coloring is applied to the base 11, the eyeglass part 1 has high fashionability. After that, the thin DLC layer is applied, the eyeglass part 1 has luxurious shine and gloss. Although DLC is a light brown coated layer, when the thickness of the thin layer is 0.05 to 1.5 micrometers as described above, color of DLC is unidentified and a desired beautiful color is realized.

DLC applied to the surface of the eyeglass part 1 can be high functional DLC having electroconductivity or water repellency depending on a desired function as the eyeglass part 1. An application of the DLC having electroconductivity prevents static electricity. An application of the DLC having water repellency gives a water-repellent function.

The surface of the eyeglass part 1 (the surface in contact with the wearer's nose) can be matted by a satin finish processing. To be matted is a state in which a plurality of minute rough parts are formed on a surface of an object. When the satin finish processing is applied to the surface of the object, rough parts are formed and the surface thereof is matted. That makes an area in close contact with the wearer's nose smaller, thereby giving a feeling of dryness to the wearer. Together with a successful slip-resistance effect, that gives the skin in contact with the eyeglasses 2 a comfortable feeling when wearing the eyeglasses 2, thereby a sticky feeling of the contact surface of the eyeglasses 2 to the skin is reduced. Further, the satin finish processing has an effect of making dirt such as fingerprint inconspicuous.

Various methods of satin finish processing can be employed. For example, a sandblasting is performed by hitting the surface of the object with compressed air mixed with so-called media, including sands, iron, and glass. A liquid honing can be performed by hitting the surface of the object with water mixed with the above media.

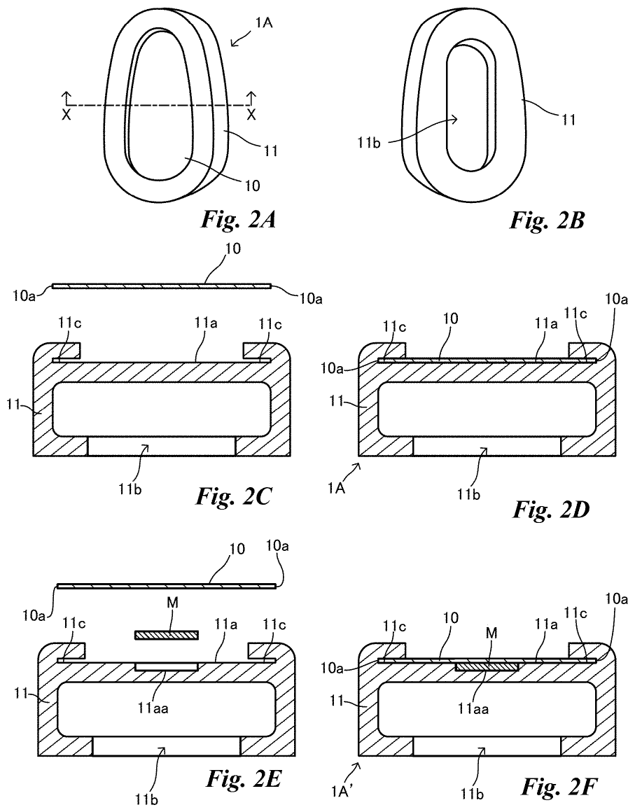

As shown in FIGS. 2E and 2F (not shown in FIG. 1), the eyeglass part 1 can have a built-in magnet. This is easily produced, for example, by adhering a magnet on the connection part 13 in advance, setting it into a mold, and performing an injection molding. A permanent magnet can be used. With respect to permanent magnets, a rare earth magnet, a samarium cobalt magnet, or a ferrite magnet can be used. Preferably, among them, a neodymium magnet that has strong magnet force can be used. When a total magnetic flux density of the magnet used for the eyeglass part 1 is, for example, 35 to 200 milliteslas, such a product can be used as a medical treatment device. Thus, the eyeglass part 1 having the magnet produces effects of removing stiffness in the body or promoting blood flow by the magnetic force of the magnet other than the above-described effects.

A shape of the eyeglass part 1 is not limited to an example shown in the drawings, and it is formed approximately the same shape as the nose pad 21 of the common eyeglasses 2. Alternatively, the eyeglass part 1 can have a projecting part 12 to be described in the third embodiment. Further, an edge of the eyeglass part 1 is not limited to an example shown in the drawings, the edge can be R-processed (chamfered).

### Second Embodiment

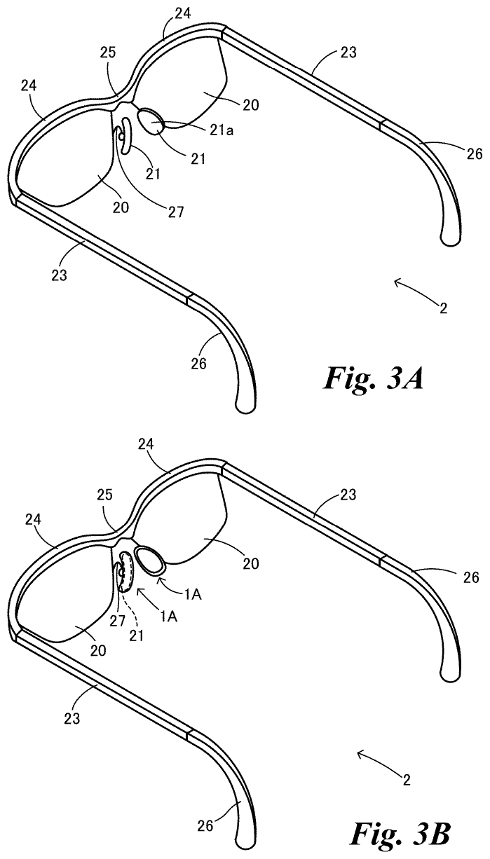

An eyeglass part 1A in accordance with the second embodiment is described with reference to FIG. 2 and FIG. 3. The eyeglass part 1A covers the nose pad 21 of the eyeglasses 2. The reference signs used in the above-described embodiments are also used for the same structure described below, and the following mainly describes different points.

(Eyeglass Part 1A)

The eyeglass part 1A shown in FIGS. 2A and 2B is approximately in the shape of a rice grain, and a carbon sheet 10 is installed on a front surface 11a side thereof where the wearer's nose comes into contact. The carbon sheet 10 is flexible, and is composed of a carbon material, specifically a carbon fiber reinforced carbon composite, having a carbon purity of 90% or greater and being crystallized by a heat treatment at 2000 degrees C. or higher. As shown in FIG. 2C and FIG. 2D, an edge 10a of the carbon sheet 10 is inserted into a slit groove 11c formed on the front surface 11a, and thereby the carbon sheet 10 is held in the base 11. A surface without coming into contact with the wearer's skin, i.e., a back surface 11b side, has a hole for covering the nose pad 21 as shown in FIG. 2B.

The carbon sheet 10 can be fixed by an adhesive on the front surface 11a side of the base 11. However, fixing by the adhesive is sometimes difficult depending on the materials of the base 11.

According to the above, the carbon sheet 10 is attached on the base 11 simply by inserting the carbon sheet 10 into the slit groove 11c.

A shape of the eyeglass part 1A can be formed approximately the same shape as the nose pad 21 of the common eyeglasses 2. Thus, the shape of the eyeglass part 1A is not limited to the shape described in this embodiment.

(Carbon Sheet)

The carbon sheet 10 is preferably composed of a flexible carbon fiber reinforced carbon composite (hereinafter referred to as “C/C composite”). Although a thickness of the carbon sheet 10 is not especially limited, for example, the thickness of 0.2 to 0.6 mm allows the carbon sheet to have flexibility. According to this, the carbon sheet 10 has a high strength and is flexible when it is attached to cover the nose pad 21, and additionally has the far-infrared radiation effect peculiar to the carbon materials.

The C/C composite is reinforced carbon with a carbon fiber. With respect to a preferable production method thereof, for example, carbon fiber reinforced plastic (CFRP), which is a fiber reinforced composite material composed of a carbon fiber and plastic (mainly the above-described thermoplastic type), can be molded and hardened, then can be heat-treated in an inert atmosphere, and a base material plastic can be carbonized. C/C of the C/C composite stands for the carbon fiber reinforced carbon.

Specifically, the C/C composite can be produced as described below.

A phenol resin molding compound (CFRP) whose core material is the carbon fiber is produced by various molding methods, is baked in vacuum at 2000 to 3000 degrees C., and portions of phenol resin are carbonized and crystallized. Then, the carbon fiber whose periphery is surrounded by carbon which is made of carbonized phenol resin is obtained. Components in the phenol resin other than carbon (hydrogen, oxygen or others) are vaporized and disappear so that many air bubbles are generated in the carbonized carbon of the phenol resin. This baked carbon of the phenol resin is impregnated under pressure with phenol resin liquid to plug these air bubbles, and after that, it is baked and carbonized. Thereby, the C/C composite is obtained. By shaving the C/C composite obtained in such manner and making a sheet thereof, the carbon sheet 10 has a carbon purity of 99.9%.

Compared with the carbon fiber reinforced plastic or glass fiber reinforced plastic, the C/C composite is light-weighted, and has a high strength, a high elastic power, and a wear resistance, thereby cracking and chipping thereof are prevented. It also has a heat resistance. Also, the C/C composite absorbs heat emitted by nose or parts of a face in contact and radiates the heat due to its high thermal conductivity, that brings a cool and refreshing feeling, and makes the eyeglasses 2 comfortable to wear. Further, the C/C composite reduces generation of static electricity due to its electroconductivity. As described above, the C/C composite, being the carbon material, has a far-infrared radiation action.

(Base)

The base 11 can be formed by mixing 20 to 50% of the graphite particles of 3 to 5 micrometers, as described in the first embodiment, with silicone resin and performing the injection molding.

According to this method, a desired shape is easily produced, and the base 11 is easily attached to the nose pad 21 of the existing eyeglasses 2. The silicone resin fits well to the skin, so that the wearer feels comfortable to wear.

The thermoplastic resins other than the above are, for example, polypropylene, polystyrene, polyamide, halogenated vinyl resin, polyacetal, polyester, polycarbonate, polyarylsulfone, polyarylketone, polyphenyleneether, polyphenylenesulfide, polyaryletherketone, polyethersulfone, polyphenylenesulfidesulfone, polyarylate, liquid crystal polyester, and fluororesin. These can be used individually or in combination of two or more of these.

The surface of the carbon sheet 10, i.e., the part in contact with the wearer's skin, can be matted by a satin finish processing, and that is the same as the first embodiment. The surface of the carbon sheet 10 can be coated with the diamond-like carbon (hereinafter referred to as “DLC”), that is also the same as the first embodiment.

FIGS. 2E and 2F are diagrams showing a variation wherein the eyeglass part 1A has a magnet M.

An eyeglass part 1A′ in this variation is configured to have a recessed part 11aa on the front surface 11a side of the base 11 where the magnet M in the shape of a flat plate is embedded, and the carbon sheet 10 is configured to be fixed over the magnet M. The magnet M can be fixed with the adhesive and the like in the recessed part 11aa. The permanent magnet can be used for the magnet M. With respect to the permanent magnets, the rare earth magnet, the samarium cobalt magnet, or the ferrite magnet can be used, and the product with the magnet can be used as a medical treatment device, like the first embodiment. Thus, the eyeglass part 1A′ having the magnet M is able to exert effects of removing stiffness in the body or promoting blood flow with magnetic force of the magnet M in addition to the above-described effects.

FIG. 3A shows a state of the eyeglasses 2 before the eyeglass parts 1A and 1A are attached on the nose pads 21, and FIG. 3B shows a state of the eyeglasses 2 after the eyeglass parts 1A and 1A are attached. The base 11 is made of silicone resin having flexibility, thereby the eyeglass part 1A is easily attached on the nose pad 21 by covering the hole on the back surface 11b side of the eyeglass part 1A.

### Third Embodiment

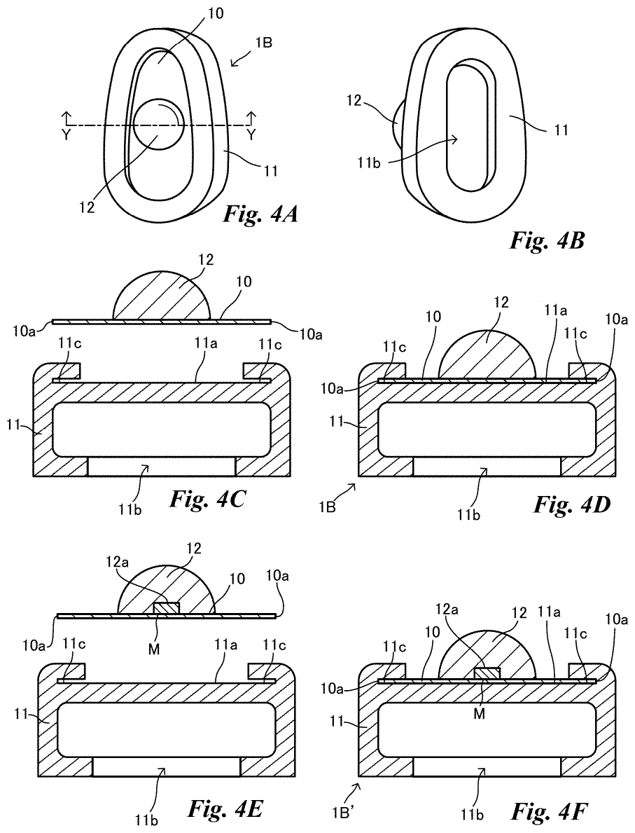

An eyeglass part 1B in accordance with the third embodiment is described with reference to FIG. 4. The eyeglass part 1B differs from the eyeglass part 1A in the second embodiment on the point that the eyeglass part 1B has a projecting part 12, and the rest of other points are in common with those in the second embodiment. The eyeglass parts 1B is respectively attached over a pair of the nose pads 21 and 21 which are parts of the eyeglasses 2. The carbon sheet 10 is installed on the front surface 11a side of the eyeglass part 1B. As shown in FIGS. 4C and 4D, the edge 10a is inserted into the slit groove 11c formed on the front surface 11a, and thereby the carbon sheet 10 is held in the base 11, like the above-mentioned embodiments. The back surface 11b side has a hole for covering the nose pad 21 as shown in FIG. 4B, like the above-mentioned embodiments. The reference signs used in the above-described embodiments are also used for the same structure described below, and the following mainly describes different points.

(Projecting Part)

One approximately hemispherical projecting part 12 whose diameter is 3 to 5 mm is formed on the carbon sheet 10 in the eyeglass part 1B. The height of the projecting part 12 (projecting dimension from the surface of the carbon sheet 10) can be about 1 to 3 mm, for example. The projecting part 12 is fixed on the carbon sheet 10 by an adhesive and the like. The shape, place to form, size, and the number of the projecting part 12 are not limited to the examples shown in the drawings, but various structures can be used. For example, the shape of the projecting part 12 can be approximately conical, polygonal pillar, or cylindrical. The projecting part 12 is preferably formed at a place where a wearer feels comfortable due to stimulation to the wearer's skin when it is attached by covering the nose pad 21. For example, it can be formed at a place where pressure points (acupuncture points) of the nose (for example, SEIMEI, literally meaning ethmoid sinus) exist. According to this, the projecting part 12, which stimulates the pressure points, exerts effects of improving eyestrain and nasal congestion.

As described in the first embodiment, the projecting part 12 can be formed by containing 20 to 50% of the crystallized graphite particles of 3 to 5 micrometers relative to the resin material, or can be composed of an isotropic high density carbon material. The isotropic high density carbon material, which is also called CIP material (CIP stands for cold isostatic press) or isotropic graphite, is a carbon material having a carbon purity of 90% or greater and being crystallized by a heat treatment at 2000 degrees C. or higher. The isotropic high density carbon material is a material that has high electroconductivity and thermal conductivity, and that radiates a large amount of far-infrared rays by using energy absorbed in forms of external heat, light or the like.

Thus, the projecting part 12, which is warmed by a temperature of a human body, resonates with tissues of the human body and radiates far-infrared rays. Thereby, a deep part of the human body is warmed and a blood flow is promoted, and that exerts a health promotion effect. Also, a portion in contact with the skin is composed of the isotropic high density carbon material having high thermal conductivity in this manner, thereby heat of the skin in contact with the isotropic high density carbon material is easily absorbed in the isotropic high density carbon material, and the skin is cooled. That brings a cool and refreshing feeling when the eyeglasses 2 are worn. Further, in the example wherein the carbon sheet 10 has the projecting part 12, the graphite particles is not required to be contained 20 to 50% in the base 11. When carbon is not contained in the carbon sheet 10, because the projecting part 12 in contact with the wearer's skin is composed of the carbon material having the carbon purity of 90% (99.9%) or greater, the above-described effects are exerted. This isotropic high density carbon material is produced by putting a raw material into a rubber made container, and uniformly pressing six faces of the container. Thus, every face is uniformly pressed so that every face has less variation of strength. Thereby, this material becomes finer and has excellent mechanical characteristics compared with other molding methods.

Specifically, the isotropic high density carbon material can be produced as described below.

First, binders, such as a phenolic adhesive, pitch, or tar, are added by 5% to a carbon material that is carbide particles such as graphite, and the mixture is filled in an elastic mold (for example, a rubber made mold). According to this embodiment, a product having a shape of the projecting part 12 is obtained by this mold. Then, the mold is sealed, submerged in a pressure vessel, and pressed by water as a pressure medium. In this manner, since the carbon material is uniformly pressed from all directions, it is randomly orientated and an isotropic lump (anisotropic ratio 1.0 to 1.1) is generated. After that, the lump of the carbon material removed from the mold is heated in an oxygen deficiency state and is eventually baked at about 2000 to 3000 degrees C. During baking, phenolic component, pitch or tar is volatilized around 1200 degrees C. when the temperature increases, the carbon material is crystallized (graphited) and has an aligned crystalline structure in high density that has the carbon purity of 90% or greater. In this manner, the isotropic high density carbon material can be produced by the above-described processes, and the projecting part 12 can be produced by carving out this raw material.

FIG. 4E and FIG. 4F are diagrams showing a variation wherein the projecting part 12 of the eyeglass part 1B has the magnet M.

An eyeglass part 1B′ in this variation has a structure wherein a recessed part 12a is formed on a back surface of the projecting part 12, and a disc-shaped magnet is embedded in the recessed part 12a. By installing the magnet M in this manner, magnetic force of the magnet M produces effects of removing stiffness in the body or promoting blood flow in addition to the above-described effects.

### Fourth Embodiment

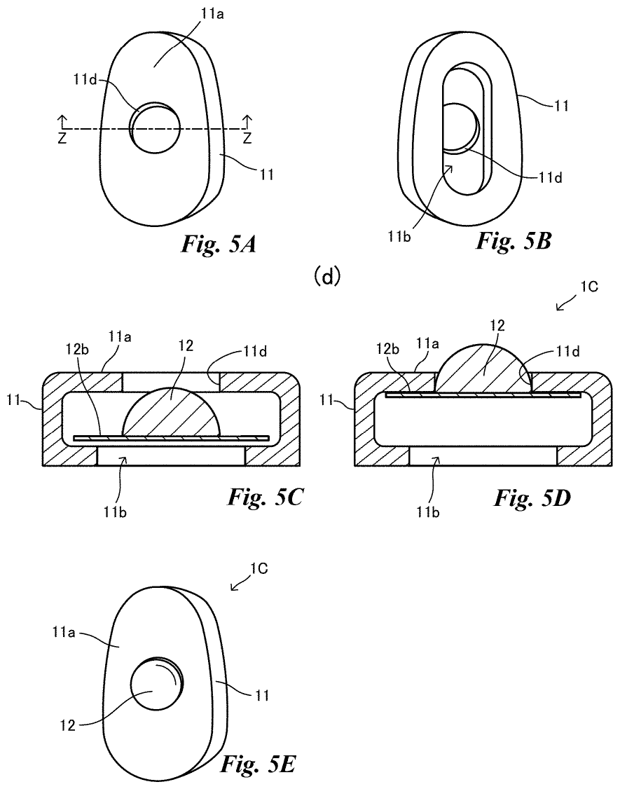

An eyeglass part 1C in accordance with the fourth embodiment is described with reference to FIG. 5.

FIG. 5A and FIG. 5B show a state before the projecting part 12 is attached to the base 11 for illustrative purposes. The reference signs used in the above-described embodiments are also used for the same structure described below, and the following mainly describes different points.

The eyeglass part 1C is a variation of the eyeglass part 1B in the third embodiment. The eyeglass part 1C is in common with the eyeglass part 1B of the third embodiment on the point that the projecting part 12 is provided, but how to arrange the projecting part 12 is different.

As shown in FIG. 5C and FIG. 5D, a flange part 12b is provided around the projecting part 12 of the eyeglass part 1C (like a peripherally brimmed hat). The projecting part 12 is fixed by being inserted from the back surface 11b to an opening 11d (see FIG. 5A and FIG. 5B) formed on the front surface 11a side of the base 11, referring to FIG. 5E. In this example, since the base 11 is made of silicone resin, elastic force peculiar to the silicone resin allows the projecting part 12 to be held without using the adhesive or the like. Therefore, the opening 11d formed on the base 11 is formed to match dimension of the diameter of the projecting part 12.

As shown in FIG. 4D and FIG. 4F, the magnet M can also be installed in this embodiment.

### Fifth Embodiment

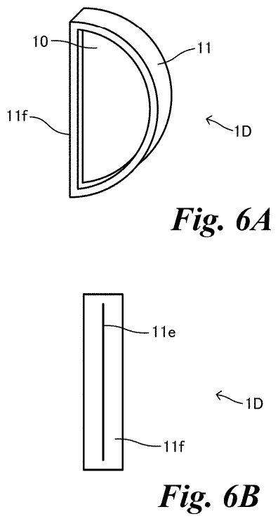

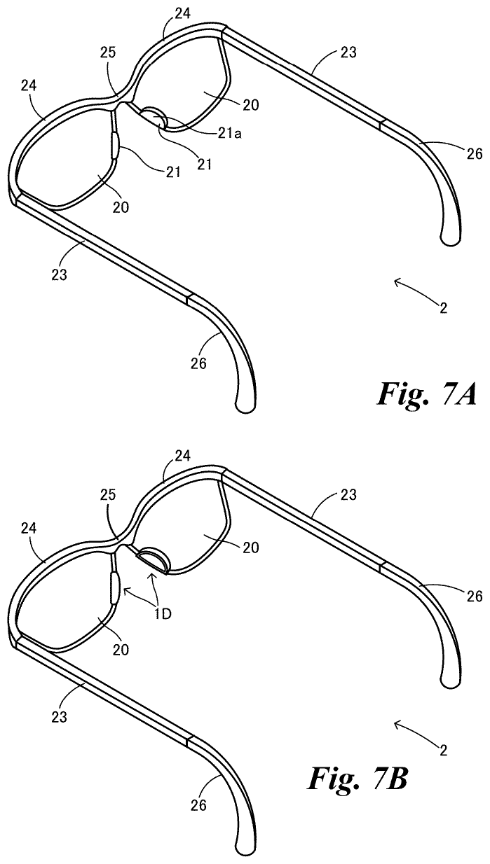

FIG. 6 and FIG. 7 show an eyeglass part 1D in accordance with the fifth embodiment. The reference signs used in the above-described embodiments are also used for the same structure described below, and the following mainly describes different points.

The eyeglass part 1D shown here is respectively attached over a pair of nose pads 21 and 21, which are parts of the eyeglasses 2, and the eyeglass part 1D is a variation of the eyeglass part 1A in accordance with the second embodiment. The eyeglass part 1D differs from the eyeglass part 1A on the point that, as shown in FIG. 6A, the eyeglass part 1D is semicircular and has a slit 11e that matches the shape of the nose pads 21 and 21 of the eyeglasses 2. The eyeglass part 1D is well suitable for the eyeglasses 2 with no pad arms as shown in FIG. 7A.

The eyeglass part 1D is in common with the eyeglass part 1A of the second embodiment on the point of a material of the base 11 and having the carbon sheet 10. The base 11 of the eyeglass part 1D is semicircular as described above, and the slit 11e is formed on a straight lateral face 11f.

Thereby, as shown in FIG. 7B, by putting the slit 11e to the nose pad 21 and inserting the eyeglass part 1D into the slit 11e, the eyeglass part 1D is easily attached by covering the nose pad 21.

Though not shown in the drawings, this eyeglass part 1D can have the projecting part 12, which is provided for the eyeglass part 1B in the third embodiment, on the carbon sheet 10, and also can have the projecting part 12 having the magnet M. As described in the first embodiment, the base 11 can be formed by containing 20 to 50% of the crystallized graphite particles of 3 to 5 micrometers relative to the resin material.

### Sixth Embodiment

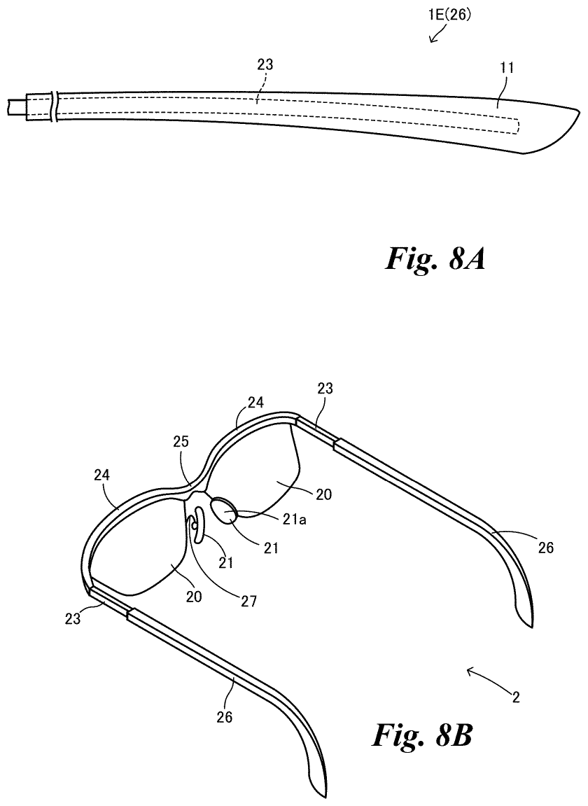

Next, another embodiment, which differs from the above-described embodiments, is described with reference to FIG. 8. The reference signs used in the above-described embodiments are used for the same structure, and different matters are mainly described.

An eyeglass part 1E is formed at a tip end of a temple 23 of the eyeglasses 2 as a temple tip 26 (an ear-hook part), and it contains the carbon material having the carbon purity of 90% or greater and crystallized by heat treatment at 2000 degrees C. or higher. Like the first embodiment, the eyeglass part 1E can be also produced in this embodiment by containing 20 to 50% of the graphite particles pulverized to more or less 3 to 5 micrometers relative to the resin material, pelletizing this resin material, supplying the pelletized pellets, which are melted by heat, to the mold, and performing the injection molding. In this case, when the base 11 contains the above-described graphite particles in the resin material such as silicone resin or polypropylene, the base 11 is curved to be an ear-hook due to its flexibility after integrally molded with the linear temple 23 as shown in FIG. 8A. FIG. 8A and FIG. 8B show an example of longer temple tip 26. Increasing an area of the temple tip 26 made of carbon material in this manner greatly exerts the above-described effects.

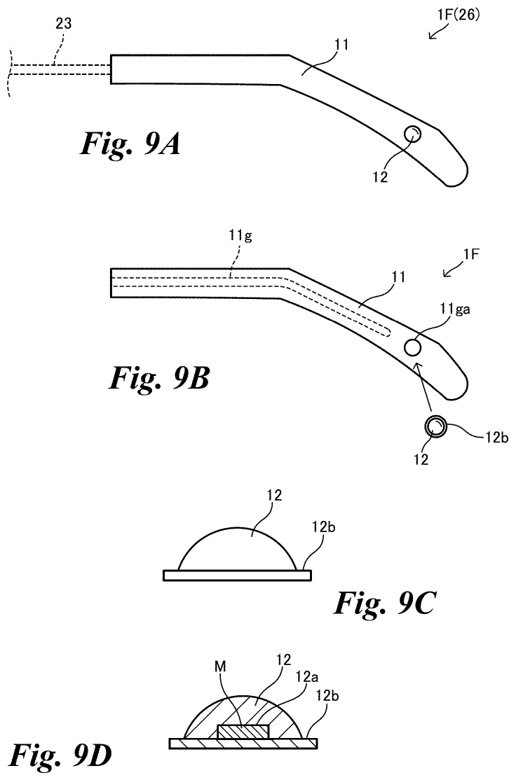

The shape and the structure of the temple tip 26 are not limited to those shown in the drawings, but can be like the temple tip 26 shown in FIG. 1C. Alternatively, the temple tip 26 can have the projecting part 12 as shown in FIG. 9 described below, or can have the magnet M as shown in FIG. 9D.

The surface of the temple tip 26, i.e., the part in contact with the wearer's skin, can be matted by the satin finish processing, and that is the same as the first embodiment. Also, the surface of the temple tip 26, i.e., the part in contact with the wearer's skin, can be coated with the diamond-like carbon (hereinafter referred to as “DLC”), and that is also the same as the first embodiment.

According to the above, the eyeglass part 1E has the same effects as the eyeglass part as described in the first embodiment.

### Seventh Embodiment

An eyeglass part 1F in accordance with the seventh embodiment is described with reference to FIG. 9. The reference signs used in the above-described embodiments are used for the same structure, and different matters are mainly described. The eyeglass part 1F is exemplary applied to the temple tip 26 in the same manner as the sixth embodiment. The eyeglass part 1E in the sixth embodiment is the example wherein the base 11 is integrally formed with the temple 23. Here, the eyeglass part 1F differs in structure on the point that the base 11 having an insertion groove 11g, which is formed to match the shape of the temple 23 of the eyeglasses 2, is formed and then the temple 23 is inserted into the insertion groove 11g. It also differs on the point that the projecting part 12 is provided at a portion where the eyeglass 2 comes into contact with a wearer's ear at the back when wearing.

As with the first embodiment, the eyeglass part 1F can be also produced in this embodiment by containing 20 to 50% of the graphite particles, which is crystallized by the high-temperature baking and pulverized to more or less 3 to 5 micrometers, relative to the resin material, pelletizing this resin material, supplying the pelletized pellets melted by heat to a mold, and performing the injection molding. In this case, when the base 11 contains the above-described graphite particles in the resin material such as the silicone resin or polypropylene, due to its flexibility, the base 11 can be configured to be inserted into the temple 23 afterwards by forming as a separate body, and it softly fits to the wearer. The base 11, which is to be the temple tip 26, has an insertion hole 11ga to insert and incorporate the flange part 12b of the projecting part 12. As shown in FIGS. 9B and 9C, a structure of the projecting part 12, which is inserted into the insertion hole 11ga and fixed thereto, is the same structure as the projecting part 12 having the flange part 12b used for the eyeglass part 1C in accordance with the fourth embodiment as shown in FIG. 5.

The projecting part 12 can be formed by containing 20 to 50% of the crystallized graphite particles of 3 to 5 micrometers relative to the resin material as described in the first embodiment, or can be made of the isotropic high density carbon material. As shown in FIG. 9D, the projecting part 12 can have the magnet M.

The projecting part 12 is formed at a portion where it can stimulate a pressure point of the ear, for example, EIFU, which is behind the earlobe, thereby it is expected that pressing the pressure point using the projecting part 12 effectively works for swelling of face, dullness, ear disease, dizziness, and the like. Further, the projecting part 12 is formed to stimulate a pressure point of the ear, JIMON, i.e., an ear gate, thereby it is expected that pressing the pressure point using the projecting part 12 effectively works for relief of headache, eyestrain, and the like.

### Eighth Embodiment

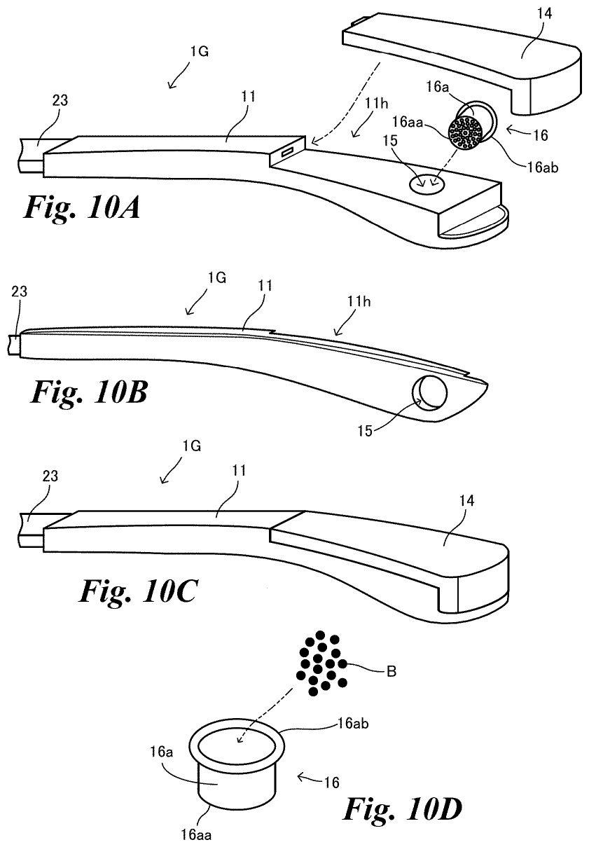

An eyeglass part 1G in accordance with the eighth embodiment is described with reference to FIG. 10. The reference signs used in the above-described embodiments are used for the same structure, and different matters are mainly described. The eyeglass part 1G is in common with the sixth and seventh embodiments on the point that it is exemplary applied to the temple tip 26, but differs on the points that it is configured to have a holding part 15 in the base 11 and have a deodorizing effect.

The eyeglass part 1G has the base 11, the perforated holding part 15 that is formed in the base 11, a pot 16 held by the holding part 15, and activated carbons B as deodorants that are stored in the pot 16. The holding part 15 is formed at a portion of the base 11 where the wearer's skin comes into contact and at an end of the base 11 which comes into contact with the ear at the back. The diameter size of the holding part 15 is formed to match the size of a pot body 16a of the pot 16 so as to fit the pot body 16a, and the diameter size thereof is set, for example, about 5 to 7 mm. Material of the pot body 16a is not particularly limited, but it can be composed of a metal material or a synthetic resin material. The base 11 has a cutout part 11h that is formed by cutting out and making a step on a side where the skin of the wearer does not come into contact. The cutout 11h is configured so as to be fitted with a slide-type cover 14. The cover 14 is capable of being tightly closed so as not to leak the activated carbons B that are stored in the pot 16. The cover 14 can be configured to be openable and closeable to replace the activated carbons B, or the pot 16 itself including the cover 14 can be configured to be replaced, when the effect of the activated carbons B is weakened. The pot 16 has the cylindrical pot body 16a that is fitted with and held in the holding part 15, a bottom part 16aa whereon a plurality of holes are formed, and a flange part 16ab to hold the pot 16 so as not to fall into the holding part 15. When the pot 16 is fitted to the holding part 15, the bottom 16aa is arranged to come into contact with the wearer's ear at the back. Many holes with diameters of, for example, 100 to 400 micrometers are formed in the bottom part 16aa to exert the effect of the activated carbons B. At this time, a processing method of the holes on the bottom 16aa is not particularly limited, but the micro holes can be formed by an etching processing or a photoetching processing.

The bottom 16aa can be flattened as shown in FIG. 10A or can be projecting as shown in FIG. 9C. When it is projecting, effects of pressing a pressure point similar to the projecting part 12 are expected.

The deodorant stored in the pot 16 is not limited to the activated carbons B, and any deodorant that exerts the deodorizing effect with a small amount is preferably used. In this embodiment, an example using porous activated carbons B as the deodorants is described. The activated carbons B used here can be any carbon material as long as they are porous and they can absorb odor. Spherical activated carbons are shown, and it is well suitable that a specific surface area per one gram is about 1700 to 1900 m². Particles of the activated carbons B that are larger than the size of the holes on the bottom 16aa, specifically particle diameters from 500 to 600 micrometers, are used.

For example, the activated carbons B can be produced as below.

Phenol resin, which is a synthetic resin material as a raw material, is pulverized, and pulverized pieces are processed to obtain a plurality of spheres. These spheres are carbonized at a high temperature, for example, about 700 to 800 degrees C., and the processed spheres are reacted with water vapor at high temperature, for example, about 900 to 1000 degrees C. (steam activation). This steam activation is able to form a porous structure. After that, the spheres are refined to remove impurities and screened to obtain the porous activated carbons B having a desired particle diameter and a desired hole diameter.

The activation can be performed by not only the steam activation but also the activation using carbon dioxide or air. Also, the activation can be performed by an alkali activation using KOH and the like. A raw material of the activated carbons B is not limited to phenol resin, but palm shells or lime can be used.

For example, B's Wiper (registered trademark), or products manufactured by the methods disclosed in Japanese Patent No. 4266711 and Japanese Patent No. 4308740 can be preferably used as the activated carbons B.

When the temple tip 26 has the deodorizing effect in this manner, odor emitted from behind the ears and back of the head, which are said to generate odor, is absorbed. Thus, for example, when the wearer is middle aged or older, it is said that so-called aging odor whose main component is nonenal is emitted from behind the ear, and the odor is effectively deodorized.

In addition to the above-described activated carbons B, a functional substance, such as a fragrance (aromatic oil, perfume), artificial enzyme, or antimicrobial agent, can be stored in the pot 16. By carrying the aromatic oil or the perfume as the fragrance, gentle fragrance is diffused from the back of ear, thereby further healing effects are expected. The artificial enzyme that has a decomposing function of oxidizing odor component with active oxygen and converting to other substance can be used. The above-described functional substances can be contained in the activated carbons B. In this case, the functional substance is dissolved or dispersed in resin solution like ionomer resin solution wherein the activated carbons B are soaked to absorb the functional substance. Because the activated carbons B are extremely porous, holes (not shown) in the activated carbon easily contain the functional substance by this method.

According to the above, in addition to the deodorizing effect, the activated carbons B absorb the odor and have the decomposing function of the odor, and thereby more persistent deodorizing effect are expected.

The structure of the holding part 15 formed in the base 11 is not limited to the example shown in the drawing, but, for example, a structure wherein a hole is formed as the holding part 15 in the base 11 and the deodorant is directly put and held in the hole-shaped holding part 15 can be employed. In this case, a cover part, which covers the hole-shaped holding part 15, is formed with a metal material, and micro holes are formed thereon by the above-described etching processing, and thereby an eyeglass part has the deodorizing effect. At this time, needless to say, the cover part is formed around behind the ear.

### Ninth Embodiment

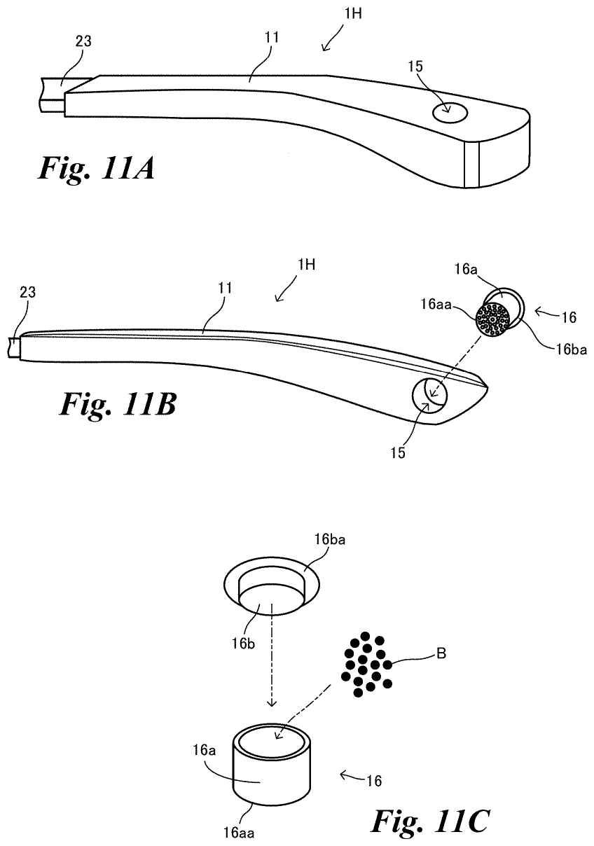

An eyeglass part 1H in accordance with the ninth embodiment is described with reference to FIG. 11.

The reference signs used in the above-described embodiments are also used for the same structure described below, and the following mainly describes different points.

It can be said that the eyeglass part 1H is a variation of the eyeglass part 1G in the eighth embodiment. The eyeglass part 1H is in common with the eyeglass part 1G on the point that it has the holding part 15 and the pot 16, but how to arrange these parts is different.

The eyeglass part 1H has the base 11, the holding part 15 formed in the base, the pot 16 that is fitted with and held in the holding part 15, and activated carbons B stored in the pot 16. The holding part 15 of this embodiment is formed as a hole that penetrates through the front and back surfaces of the base 11. The pot 16 has the cylindrical pot body 16a that is fitted with the holding part 15, the bottom part 16aa whereon a plurality of holes are formed, and the flange part 16ba to hold the pot 16 so as not to fall into the holding part 15. The cover 16b is configured to be able to be tightly closed not to leak the activated carbons B that are stored in the pot body 16a. Many holes with diameters of, for example, 100 to 400 micrometers are formed in the bottom part 16aa to exert the effect of the activated carbons B, and the bottom part 16aa is arranged so as to come into contact with behind a wearer's ear, like the eighth embodiment. The activated carbons B that are stored in the pot 16 are not limited to the activated carbons like the eighth embodiment and can be a bead-like deodorant, as long as the deodorant absorbs odor. Alternatively, a mixture of the above-described functional substances and fragrances with the activated carbons can be stored in the pot 16, or the activated carbons can contain the functional substances as described above. Further, needless to say, the fragrance only can be stored in the pot 16.

### Tenth Embodiment

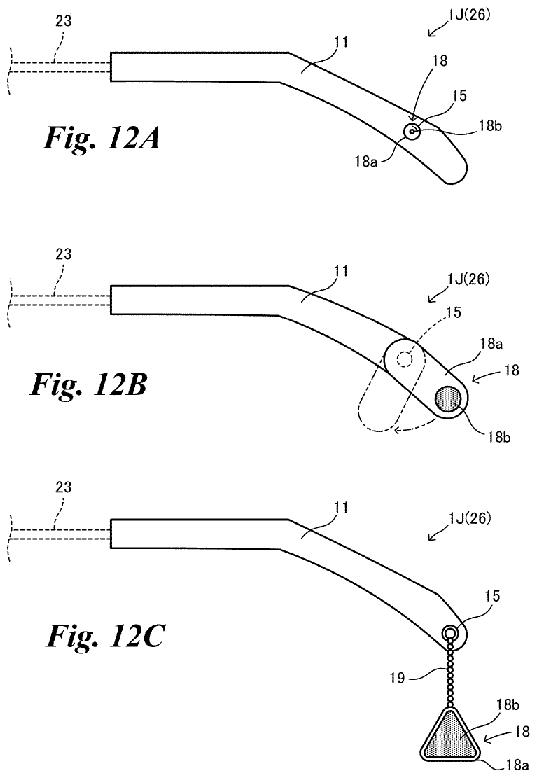

An eyeglass part 1J in accordance with the tenth embodiment is described with reference to FIG. 12.

The reference signs used in the above-described embodiments are also used for the same structure described below, and the following mainly describes different points. It can be said that the eyeglass part 1J is a variation of the eyeglass parts 1G and 1H in the eighth and ninth embodiments. The eyeglass part 1J is in common with these on the point that it has the holding part 15 and deodorant, but it differs on the point of a structure of the holding part 15, and on the point that the deodorant is stored in various cases 18.

The eyeglass part 1J in FIG. 12A has the base 11, the holding part 15 formed in the base11, the case 18 held by the holding part 15, and deodorant that is stored in the case 18. The holding part 15 in this embodiment is formed into a recessed shape so as to hold the projecting case 18 on a front surface of the base 11 without coming into contact with the wearer's skin. The case 18 has a case body 18a that is fitted with and held in the holding part 15, and a round-shaped aeration part 18b. The semicircular dome-shaped case body 18a stores the deodorant described in the eighth embodiment. The material of the case body 18a is not particularly limited, but a metal material or a synthetic resin material can be used. The diameter size of the holding part 15 is formed to match the diameter size of the case body 18a of the case 18 so as to fit the case body 18a, and the diameter size thereof is, for example, about 4 to 7 mm. The case 18 can be configured to be detachable by forming a groove wherein an end of the case body 18a and the recessed holding part 15 are screwed each other, and the case 18 itself can be replaced when the deodorant effect is weakened. The detachable structure is not limited to the screwing structure. As with the eighth embodiment, any deodorant can be stored in the case 18 if it absorbs odor. Alternatively, a mixture of the above-described functional substances with the fragrance or the activated carbons can be stored in the case 18, or the activated carbons can contain the functional substances as described above. The size of the aeration part 18b is not particularly limited; however, needless to say, the aeration part 18b is configured to be able to exert the deodorant effect with no leaking of the deodorant. Also, the shape of the case 18 is not limited to the example shown in the drawing, but as long as the case contains the deodorant and exerts the effect of the deodorant, any shape can be used. When the case 18 is small as shown in FIG. 12A, it can be said that it is well suitable because the case 18 is indistinctive when the wearer wears the eyeglasses. Further, needless to say, only the fragrance can be stored in the case 18, without the deodorant.

The eyeglass part 1J shown in FIG. 12B is another example wherein the structure of the case 18 differs from that in FIG. 12A. The case body 18a of the case 18 is approximately oval in a flat plan view, and the case 18 is held by the holding part 15 that rotatably supports one end of the case body 18a. The holding part 15 is formed at the end of the base 11 (a tip end side of the temple tip 26). The case 18 has a mesh aeration part 18b on a front side (a side that does not face a wearer's skin) thereof. The case 18 is rotatably installed in the tip end side of the temple tip 26, so that the wearer is able to adjust the position of the case 18 as desired. Also, when the case 18 has a detachable structure, it is replaceable as a part when the effect of deodorant is weakened. Further, when the aeration part 18b is freely attached to the front or the back, it is adjusted according to the wearers preference. Furthermore, the case 18 can be configured to incorporate the magnet as described in the first and second embodiments. In such a case, magnet force of the magnet is capable of producing effects of eliminating the stiffness of the body or improving the blood flow. The structure of the case body 18a and the aeration part 18b is not limited to an example shown in the drawing, but the case body 18a is configured to be able to exert the deodorizing effect without leaking the deodorant.

The eyeglass part 1J shown in FIG. 12C is another example of the case 18 and the holding part 15 whose structures differ from those shown in FIG. 12A and FIG. 12B. The case 18 shown here has a shape obtained by imaging an accessory like earrings for women, and its shape is not limited to the example shown in the drawing. FIG. 12C shows the case 18 approximately in the shape of a triangle with a flat case body 18a. A chain 19 is inserted into the hole-like holding part 15 formed at a tip end side of the base 11 that configures the temple tip 26 and the case 18 is arranged at a tip end of the chain 19. The case 18 has the mesh aeration part 18b on either surface thereof. In this example in the drawings, since the case body 18a is hanging from the chain 19, the case 18 and the chain 19 look like an earring upon wearing eyeglass 2. Thereby, the wearer enjoys them like an accessory. When a fragrance such as perfume is stored in the case body 18a of the case 18 other than a deodorant, the wearer enjoys its fragrance.

The shape of the case body 18a is not limited to the example in the drawing, but can be a sphere or a capsule-like form. The structure of the aeration part 18b is not limited to the example shown in the drawing, but it can be formed into a spiral shape as long as it has a structure wherein it exerts the deodorant effect without leaking the deodorant. Alternatively, the aeration part 18b can be arranged on both surfaces without limiting to one surface. When the aeration part 18b is arranged on one surface, decorations or patterns such as bijou parts can be applied on another surface. Also, when the case 18 is configured to be detachably arranged to the holding part 15, it is replaceable as a part when the effect of the deodorant is weakened, or depending on how the wearer feels on the day.

### Eleventh Embodiment

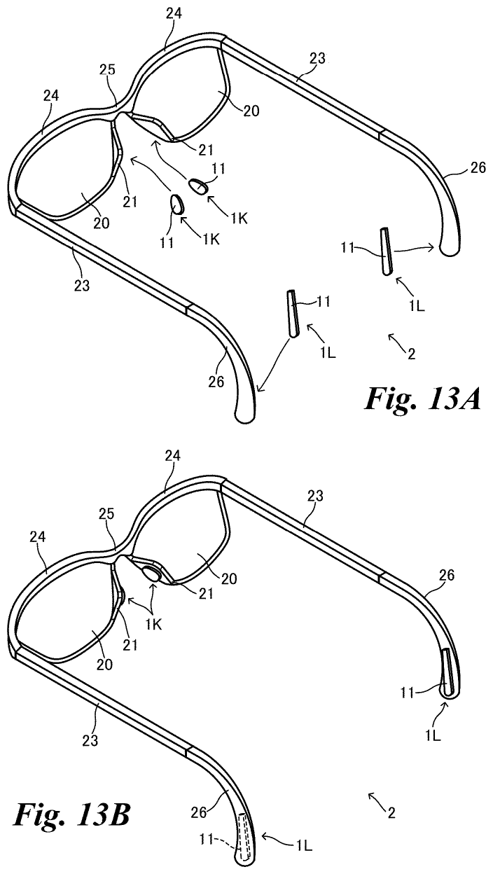

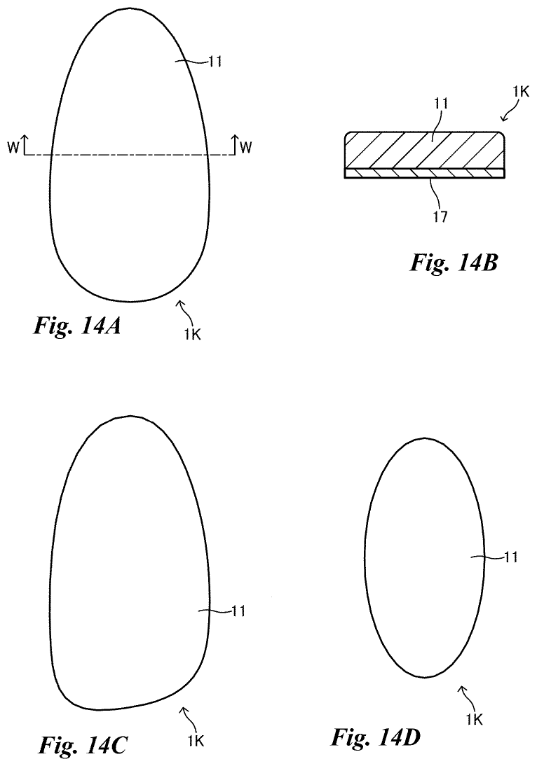

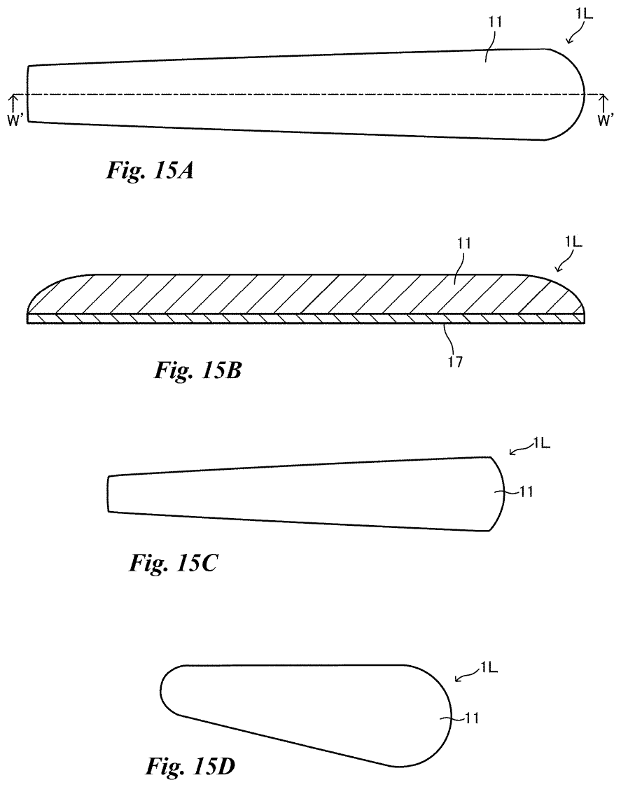

Eyeglass parts 1K and 1L in accordance with the eleventh embodiment are described with reference to FIGS. 13 to 15. The eyeglass part 1K shown here is attached over a pair of nose pads 21 and 21, which are parts of the eyeglasses 2. The eyeglass part 1L shown here is formed at the tip of temple 23, and is attached over the temple tip 26 that is the ear-hook part. Both the eyeglass parts 1K and 1L are in common with the above-described embodiments on the point that these parts are configured to contain the carbon material that has the carbon purity of 90% or greater and that is crystallized by the heat-treatment at 2000 degrees C. or higher, but differ on the point that these have fixable adhesive layers 17 (see FIG. 14B and FIG. 15B) on the nose pads 21 and the temple tips 26. The reference signs used in the above-described embodiments are also used for the same structure described below, and the following mainly describes different points.

(Eyeglass Part 1K)

The eyeglass part 1K shown in FIG. 13 and FIG. 14 has the approximately rice-shaped base 11 and the adhesive layer 17 to be fixed on the nose pad 21 (see FIG. 14B).

The base 11 in contact with a wearer's nose can be formed by containing 20 to 50% of the graphite particles of 3 to 5 micro-meters relative to the thermoplastic resin material and performing the injection molding, or by shaving the C/C composite or the isotropic high density carbon material.

The eyeglass part 1K is fixed on the nose pad 21 and has 1 to 2 mm thinness, and its edge is rounded (chamfered) so that the wearer wearing the eyeglasses 2 feels comfortable and does not feel discomfort. Various DLC processing and satin-finish processing can be applied to a front surface of the base 11 (the surface which comes into contact with the wearer's nose).

Though not shown in the drawings, the eyeglass part 1K can be formed by attaching the carbon sheet 10 described in the second embodiment on the base 11 that is previously formed with the resin material, or can have the projecting part 12 described in the third embodiment and shown in FIG. 4 and others. Further, the projecting part 12 can have the magnet M.

(Adhesive Layer)

The adhesive layer 17 can be an adhesive tape material or an adhesive as long as it fixes the base 11 on the nose pad 21. Alternatively, the adhesive layer 17 can be gel that is cohesive and capable of repeatedly pasting. A layer thickness of the adhesive layer is set about 0.03 to 0.5 mm.

According to the above, the eyeglass part 1K is able to be fixed to the existing eyeglasses 2 as a post attachment, and each wearer is able to customize the eyeglasses to have the far-infrared ray effect, the heat dispersing property, the stress reduction effect, or others.

FIG. 14A shows an example of the base 11 that is formed into approximately rice-shaped, but the base 11 is not limited to such a shape and can be a slightly distorted circle as shown in FIG. 14C or an oval as shown in FIG. 14D depending on the shape of the nose pad 21.

(Eyeglass Part 1L)

The eyeglass part 1L shown in FIG. 13 and FIG. 15 has the slender and approximately rectangular base 11 and the adhesive layer 17 to be fixed on the temple tip 26 (see FIG. 15B).

As with the eyeglass part 1K, the base 11 in contact with the wearer's nose can be formed by containing 20 to 50% of the graphite particles of 3 to 5 micrometers relative to the thermoplastic resin material and performing the injection molding, or by shaving the C/C composite or the isotropic high density carbon material.

The eyeglass part 1L is fixed on the temple tip 26 and has 1 to 3 mm thinness, and its edge is rounded (chamfered) so that the wearer wearing the eyeglasses 2 feels comfortable and does not feel discomfort when the eyeglasses 2 come into contact with the wearer's ear at the back. Also, various DLC processing and satin-finish processing can be applied to the front surface of the base 11 (where the wearer's nose comes into contact) in this embodiment.

Though not shown in the drawings, the eyeglass part 1L can be formed by attaching the carbon sheet 10 described in the second embodiment on the base 11 that is formed with the resin material, or cam have the projecting part 12 described in the third embodiment and shown in FIG. 4 and others. Further, the projecting part 12 can have the magnet M.

(Adhesive Layer)

The adhesive layer 17 can be the adhesive tape material or the adhesive as long as it fixes the base 11 on the temple tip 26. Alternatively, the adhesive layer 17 can be the gel that is cohesive and capable of repeatedly pasting. A layer thickness of the adhesive layer is set about 0.03 to 0.5 mm.

According to the above, the eyeglass part 1L is able to be fixed to the existing eyeglasses 2 as a post attachment, and each wearer is able to customize the eyeglasses to have the far-infrared ray effect, the heat dispersing property, or the stress reduction effect, or others.

FIG. 15A shows an example of the base 11 that is approximately formed into a square with its one end curved, but its shape is not limited to this. The base 11 can be a narrow fan shape as shown in FIG. 15C or both ends thereof can be semicircular as shown in FIG. 15D depending on the shape of the temple tip 26.

The above eyeglasses 2 to which the eyeglass parts 1, 1A to 1L are attached are not limited to the examples shown in the drawings, and the shape and the structure of each part of the eyeglasses 2 including the lens 20, the nose pad 21, the temple 23, the rim 24, the bridge 25, and the temple tip 26, are not limited to the examples shown in the drawings. Also, a hinge to fold the temple of the eyeglasses 2 is omitted in the examples of the drawings, but it is needless to say that the present invention is applicable for eyeglasses with the hinge. Further, although the nose pad 21 and the temple tip 26 are described as the applicable examples of the eyeglass parts, parts that configure the rim 24, the bridge 25, and the temple 23 can be produced by using the above-described carbon material. Furthermore, with respect to the structure wherein the deodorant is stored in the pot 16, that is not limited to the examples shown in the drawings. Basically, a structure can be sufficient as long as the odor can be effectively deodorized by arranging the pot 16 where it comes into contact with the wearer's ear at the back.

### DESCRIPTION OF REFERENCE SIGNS

1, 1A-1L eyeglass part
10 carbon sheet
11 base
11a front surface
12 projecting part
15 holding part
17 adhesive layer
21 nose pad
26 temple tip

1. An eyeglass part of eyeglasses, the eyeglass part comprising:
a carbon material having a carbon purity of 90% or greater and being crystallized by a heat-treatment at 2000 degrees C. or higher.

2. The eyeglass part according to claim 1,
wherein the carbon material is graphite particles and the eyeglass part is formed by containing 20 to 50% of the graphite particles of 3 to 5 micrometers relative to a resin material.

3. The eyeglass part according to claim 1,
wherein the carbon material is a carbon sheet with flexibility that comprises a carbon fiber reinforced carbon composite,
wherein a base of the eyeglasses comprises a resin material, and
wherein the carbon sheet is provided on a surface of the base with which wearer's skin comes into contact.

4. The eyeglass part according to claim 3,
wherein the resin material is silicone resin, and
wherein the base is formed by containing 20 to 50% of graphite particles of 3 to 5 micrometers relative to the silicone resin.

5. The eyeglass part according to claim 1,
wherein the eyeglass part has a projecting part projecting towards wearer's skin, the projecting part comprising an isotropic high density carbon material.

6. The eyeglass part according to claim 1,
wherein the eyeglass part has an adhesive layer that is fixable to the eyeglasses.

7. The eyeglass part according to claim 1,
wherein diamond-like carbon or an electroconductive coating is applied on a portion with which wearer's skin comes into contact.

8. The eyeglass part according to claim 1,
wherein the eyeglass part has a holding part that provided for the base of the eyeglass and deodorant that is stored in the holding part.

9. The eyeglass part according to claim 8,
wherein fragrance, or artificial enzyme that absorbs and decomposes odor is further stored in the holding part.

10. Eyeglasses comprising the eyeglass part according to claim 1.

11. Eyeglasses comprising the eyeglass part according to claim 2.

12. Eyeglasses comprising the eyeglass part according to claim 3.

13. Eyeglasses comprising the eyeglass part according to claim 4.

14. Eyeglasses comprising the eyeglass part according to claim 5.

15. Eyeglasses comprising the eyeglass part according to claim 6.

16. Eyeglasses comprising the eyeglass part according to claim 7.

17. Eyeglasses comprising the eyeglass part according to claim 8.

18. Eyeglasses comprising the eyeglass part according to claim 9.
